(19) United States
(12) Patent Application Publication
(10) Pub. No.: US 2011/0006189 A1
(43) Pub. Date: Jan. 13, 2011

(54) DOUBLE-LENS OPTICAL SCANNING DEVICE AND METHOD OF USING THE SAME

(76) Inventors: Wei-Chao KAO, Taipei Hsien (TW); Chun-Hsiao LEE, Taipei Hsien (TW); Hsin-Wen LEE, Taipei Hsien (TW)

Correspondence Address: Muncy, Geissler, Olds & Lowe, PLLC, 4000 Legato Road, Suite 310, FAIRFAX, VA, 22033, US

(21) Appl. No.: 12/549,834

(22) Filed: Aug. 28, 2009

(30) Foreign Application Priority Data
Jul. 10, 2009 (TW) 098123412

(51) Int. Cl. G02B 27/40

(52) U.S. Cl. 250/201.4; 250/578.1

(57) ABSTRACT

A double-lens optical scanning device and method of using the same. Wherein, a housing of said optical scanning device is provided with a photograph cartridge insertion slot and a negative cartridge insertion slot, that can be inserted photograph-, negative-, or slide-to-be-scanned. Said housing comprises a light source, two optical lenses, and at least an image sensor. Said two optical lenses are provided with different light paths, such that said image sensor is utilized to determine a category of an object-to-be-scanned, in selecting said optical lens to be used and a direction of said light source. A switching circuit is utilized to switch said optical lens to be used, fetch an image of said object-to-be-scanned, and then focus it onto said image sensor to form said image, and convert it into digital data for output.

### BACKGROUND OF THE INVENTION

1. Field of the Invention

The present invention relates to an optical scanning device, and in particular to an optical scanning device having two switchable optical lenses of different light paths and method of using the same.

2. The Prior Arts

In general, a conventional camera utilizes photosensitive films as negatives, however, the film negative is not easy to preserve, since images thereon will deteriorate along with the time or even disappear, thus it can not be used to produce the original images thereon, in addition, it is rather difficult to restore the images on the conventional negatives, and this could cause disappointment and inconvenience to the users. Along with the progress of digital technology and market demand, such that in addition to being capable of scanning documents and drawings, in order to fulfill the negative scanning functions, a backlight source is further provided, so that images on photographs and negatives can be converted into digital data through utilizing a special dedicated scanning device, and then the digital data are stored in a computer.

For the existing photograph scanner currently on market, those that are capable of scanning photographs, negatives, and positives simultaneously usually are very voluminous and occupy quite a lot of space. However, since it is provided with only one optical lens, and it has only one optical path, thus the photograph and negative to be scanned are placed side-by-side adjacent to each other, yet in order to have the same scanning depth, the width of a scanner has to be increased, such that its volume has to be increased. For a scanner of small size, that can only be provided with a single function of scanning photograph or negative, and it is not capable of achieving the objective of one-machine-multi-applications.

In view of the problems and shortcomings of the prior art, the present invention discloses a double-lens optical scanning device and method of using the same, so as to overcome the problems of the prior art.

### SUMMARY OF THE INVENTION

A major objective of the present invention is to provide a double-lens optical scanning device and method of using the same, that is capable of scanning negative, photograph, and slide. Wherein, optical lenses having different light paths are switched in achieving the objective of scanning different objects-to-be-scanned.

Another objective of the present invention is to provide a double-lens optical scanning device and method of using the same, wherein, two image sensors are provided, and each of them is integrated with one of the two optical lenses respectively; or, alternatively, one image sensor is provided, and that is independent from the optical lens.

In order to achieve the above-mentioned objective, the present invention provides a double-lens optical scanning device, that is essentially a housing, comprising: at least two scanning stands, used to place at least an object-to-be-scanned; a light source, used to irradiate the object-to-be-scanned; two optical lenses, that includes a first optical lens and a second optical lens having different light paths, and one of them is used to obtain the image of object-to-be-scanned, and then project it onto at least an image sensor for focusing it to form an image, in addition, the image sensor is used to sense that the object-to-be-scanned is in which scanning stand, so as to turn on the corresponding optical lens through a switching circuit.

Moreover, the present invention provides a double-lens optical scanning method, that is applicable to a double-lens optical scanning device, including the following steps: irradiating an object-to-be-scanned with a light source; sensing that the object-to-be-scanned on a negative or a photograph by using at least an image sensor; turning on one of two optical lenses selected through a switching circuit; upon controlling the light source in irradiating the objects-to-be-scanned, fetching the image of object-to-be-scanned by the optical lens, and focusing it onto an image sensor to form an image, then converting it into digital data for output.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a perspective view of a double-lens optical scanning device according to an embodiment of the present invention;

FIG. 2 is a schematic diagram of a double-lens optical scanning device illustrating that a photograph cartridge insertion slot and a negative cartridge insertion slot are inserted respectively with a photograph cartridge, a negative cartridge or a slide cartridge;

FIG. 3 is a perspective view of the internal portion of the double-lens optical scanning device according to an embodiment of the present invention;

FIG. 4 is a schematic diagram of optical paths of the double lenses according to an embodiment of the present invention;

FIG. 5 is a flowchart of the steps of the double-lens optical scanning method according to an embodiment of the present invention; and

FIG. 6 is a schematic diagram of a switching structure used for switching optical lens for a double-lens optical scanning device having double optical lenses and a single image sensor.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

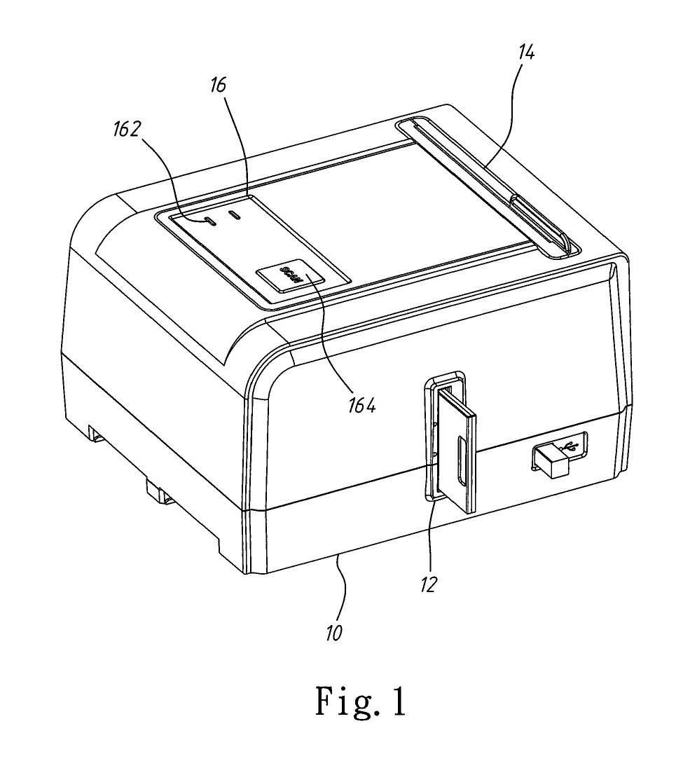

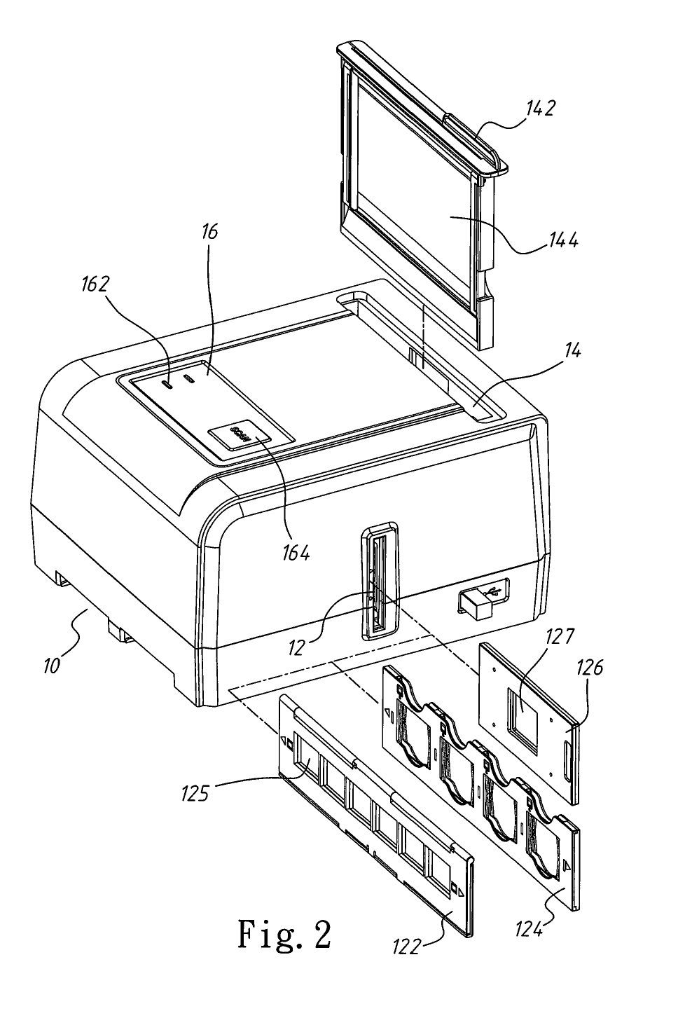

The present invention provides a double-lens optical scanning device and method of using the same. Refer to FIG. 1 for a perspective view of a double-lens optical scanning device of the present invention. Also, refer to FIG. 2 for a schematic diagram of a double-lens optical scanning device illustrating that a photograph cartridge insertion slot and a negative cartridge insertion slot are inserted respectively with a photograph cartridge, a negative cartridge or a slide cartridge. As shown in FIGS. 1 & 2, the double-lens optical scanning device comprises: a housing 10, a negative cartridge insertion slot 12, a photograph cartridge insertion slot 14, and a control panel 16. The negative cartridge insertion slot 12 can be inserted with a negative cartridge 122 containing negatives 125, or slide cartridges 124 and 126 containing slides 127; while the photograph cartridge insertion slot 14 can be inserted with a photograph cartridge 142 containing photographs 144. At least an indication lamp 162 and at least a press key 164 are provided on the control panel 16. The indication lamp 162 indicates a power-on/power-off state or a scanning state; while the press key 164 may include a power key and operation keys, used for actively selecting scanning photographs, negatives, or slides (namely, positive).

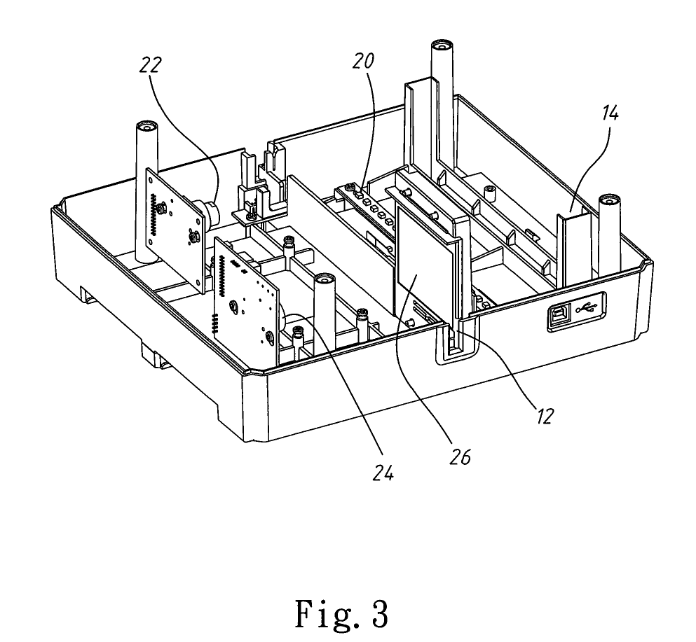

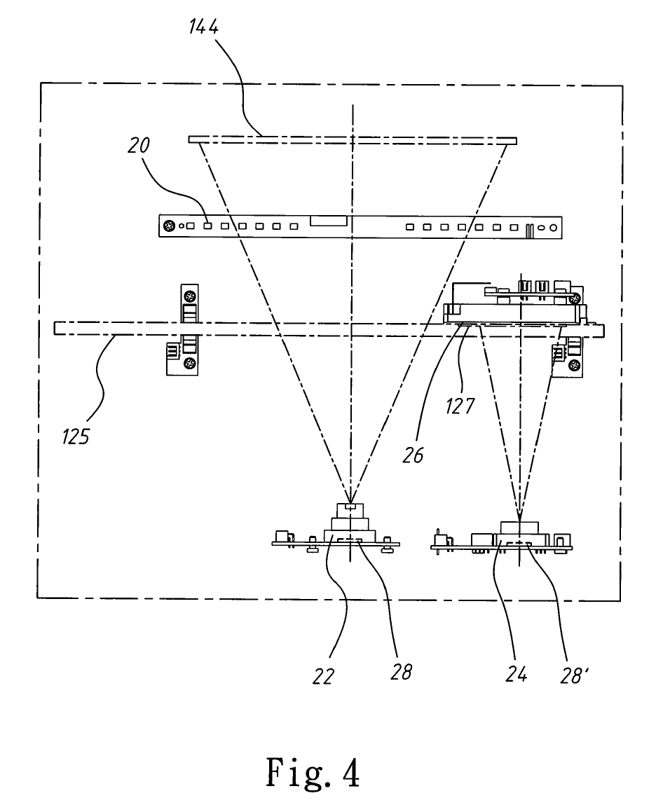

FIG. 3 is a perspective view of the internal portion of the double-lens optical scanning device according to an embodiment of the present invention. As shown in FIG. 3, the internal portion of the double-lens optical scanning device includes a first optical lens 22, a second optical lens 24, a first light source 20, and a second light source 26. Wherein, the first light source 20 is a set of LED's, and the second light source 26 is a backlight plate. Moreover, refer to FIG. 4 for a schematic diagram of optical paths of double lenses according to an embodiment of the present invention, wherein, light path of the first optical lens 22 is a distance from the first optical lens 22 to a photograph 144, the light path of the second optical lens 24 is the distance from the second optical lens 24 to a slide 127. When the object-to-be-scanned is a negative 125, the first light source 20 turns backward to irradiate on the negative 125; when the object-to-be-scanned is a photograph 144, the first light source 20 turns forward to irradiate on the photograph 144; and when the object-to-be-scanned is a slide 127, the second light source 26 irradiates on the slide 127.

In the present embodiment, at least an image sensor is further provided, that is an array type complimentary metal-oxide-semiconductor (CMOS) or a charge coupled device (CCD), such that when the number of image sensors is equal to that of the optical lenses, namely, when there are two image sensors, then refer to FIG. 4, wherein, image sensors 28 and 28′ are integrated into the inside and the rear of optical lenses 22 and 24 respectively, as such the image of object-to-be-scanned fetched by the optical lenses 22 and 24 is focused on image sensors 28 and 28′ to form an image, then the image is converted into digital data for output.

Meanwhile, refer to FIGS. 1 to 4 at the same time, wherein, a main machine board (not shown) is provided, and that is connected to the first optical lens 22, the second optical lens 24, the first light source 20, the second light source 26, the control panel 16, and the image sensors 28 and 28′, and as such that is used to determine the switching of the optical lenses and light sources to be utilized, control the turn-on/turn-off of the indication lamp 162 and press keys 164, and receive the digital data output by the image sensor, and then store the digital data into a storage device (not shown).

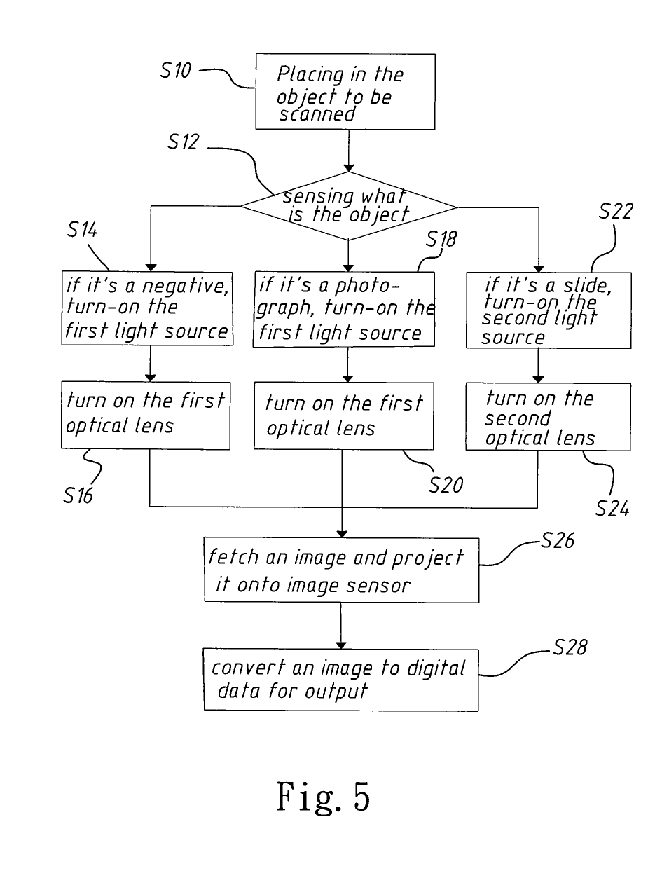

Refer to FIG. 5 for a flowchart of the steps for a double-lens optical scanning method according to an embodiment of the present invention. Wherein, in Step S10, putting in an object-to-be-scanned, next, in Step 12, sensing and determining by the image sensor that if the object-to-be-scanned is a negative, a photograph, or a slide. In case that object-to-be-scanned is a negative, then as shown in Steps S14˜S16, outputting signals to a switching circuit to turn on a first light source used for irradiating a negative and making it irradiate toward the negative, and turning on the first optical lens; in case that object-to-be-scanned is a photograph, then as shown in Steps S18˜S20, outputting signals to a switching circuit by an image sensor to turn on a first light source used for irradiating onto a photograph and making it irradiate toward the photograph, and turning on the first optical lens; and in case that object-to-be-scanned is a slide, then as shown in Steps S22˜S24, outputting signals to a switching circuit by an image sensor to turn on a second light source, and turning on the second optical lens.

Subsequently, upon turning on a light source and an optical lens, as shown in Step S26, fetching an image of the object-to-be-scanned by the first or second optical lens, and focusing it on an image sensor to form an image; and finally, in Step S28, converting the image into digital data by the image sensor for output.

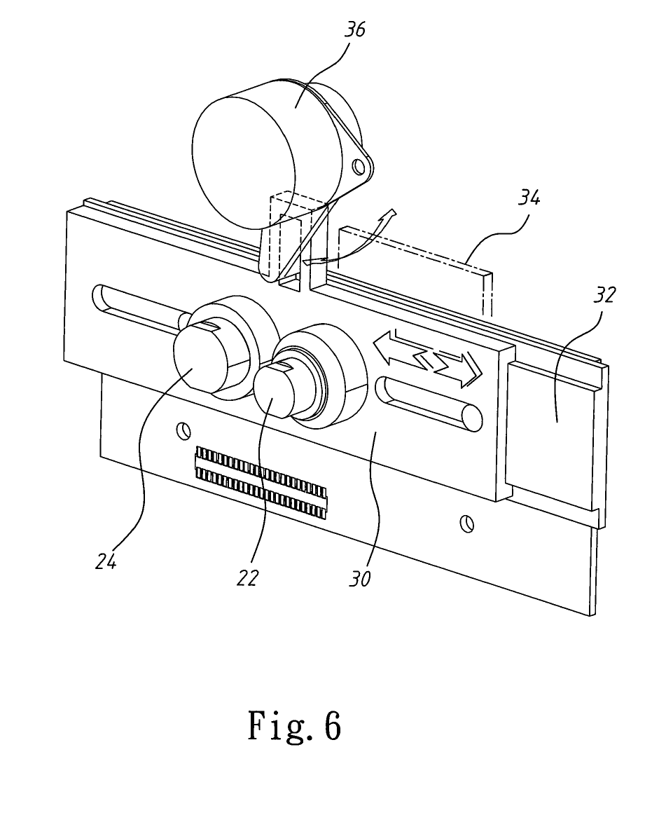

In another embodiment of the present invention, only one image sensor is provided. Refer to FIG. 6 for a schematic diagram of a switching structure used for switching optical lens for a double-lens optical scanning device having double optical lenses and a single image sensor. As shown in FIG. 6, the first and second optical lenses 22 and 24 can be disposed on a lens fixing stand 30, and this lens fixing stand 30 can move on a lens sliding stand 32, such that the first and second optical lenses 22 and 24 can also be moved. The image sensor 34 is independent from the first and second optical lenses 22 and 24, and is connected electrically to the two optical lenses 22 and 24. The overlapped double light paths can be used to perform scanning on a negative, a photograph, and a slide. In this respect, a sliding mechanism is used to move the first and second optical lenses 22 and 24 to the front of an image sensor, then rotate or move a transfer switch 36 to move the first and second optical lenses 22 and 24, and then perform the switching required in realizing the change of scanning light path. Finally, focusing an image of the object-to-be-scanned thus fetched on an image sensor to form an image, and converting it into digital data for output.

Summing up the above, in the present invention, the double-lens optical scanning device can be arranged into two embodiments of: double optical lenses and double image sensors, and double optical lenses and a single image sensor. Since the optical paths for the optical lenses in the two embodiments are different, therefore in a same scanning device, functions of scanning negatives, scanning photographs, and scanning positives can be realized through switching the optical lenses. In addition, since the placement positions of a negative and a photograph are different and not in a side-by-side juxtaposition arrangement, thus the volume of scanning device can be reduced.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A double-lens optical scanning device, that is essentially a housing, comprising:
at least two scanning stands, used to place at least an object-to-be-scanned;
a light source, used to irradiate said object-to-be-scanned;
two optical lenses, including a first optical lens and a second optical lens having different light paths, used to obtain an image of said object-to-be-scanned, and then project it out; and
at least an image sensor, used to sense said object-to-be-scanned is at which scanning stand, turn on said optical lens through a switching circuit in focusing said image of said object-to-be-scanned to form said image on said image sensor.

2. The double-lens optical scanning device as claimed in claim 1, wherein said scanning stand includes: a negative scanning stand, a photograph scanning stand, and a slide scanning stand.

3. The double-lens optical scanning device as claimed in claim 2, wherein said negative scanning stand and said slide scanning stand are placed in a side-by-side juxtaposition arrangement.

4. The double-lens optical scanning device as claimed in claim 3, wherein a light path between said photograph scanning stand and said optical lens is longer, while said light paths between said negative scanning stand, said slide scanning stand and said optical lens are shorter.

5. The double-lens optical scanning device as claimed in claim 1, wherein said light source is located between said two scanning stands.

6. The double-lens optical scanning device as claimed in claim 1, wherein upon sensing said scanning-stand-to-be-scanned by said image sensor, said switching circuit further controls said light source in irradiating said scanning stand.

7. The double-lens optical scanning device as claimed in claim 2, wherein a photograph cartridge insertion slot is located on an upper portion of said housing, a photograph of said object-to-be-scanned is inserted into a photograph cartridge, and said photograph cartridge is inserted into said photograph cartridge insertion slot, such that said photograph cartridge is placed in said photograph scanning stand.

8. The double-lens optical scanning device as claimed in claim 2, wherein a negative cartridge insertion slot is located on a side of said housing, and a negative of said object-to-be-scanned is placed in a negative cartridge, said negative cartridge is inserted into said negative cartridge insertion slot, such that said negative cartridge is placed in said negative scanning stand.

9. The double-lens optical scanning device as claimed in claim 1, wherein a control panel is further provided on said housing, and a plurality of press keys and at least an indication lamp are provided thereon, so as to control switch-on/switch-off of a power source and scanning of said object-to-be-scanned.

10. The double-lens optical scanning device as claimed in claim 1, wherein said optical lens is disposed on a lens fixing stand, said lens fixing stand can slide on a lens sliding stand, such that said light paths of said first and second optical lenses overlap, then rotate or move a transfer switch in switching said optical lens into operation.

11. The double-lens optical scanning device as claimed in claim 1, wherein said image sensor is an array type Complementary Metal-Oxide-Semiconductor (CMOS) or Charge Couple Device (CCD) image sensor.

12. The double-lens optical scanning device as claimed in claim 1, further comprising: a main machine board, connected to each of said elements mentioned above and a storage device, for storing said images scanned into said storage device.

13. The double-lens optical scanning device as claimed in claim 1, wherein said light source is a set of light-emitting-diodes (LED's).

14. A double-lens optical scanning method, applicable to an optical scanning device, comprising the following steps:
irradiating an object-to-be-scanned with a light source, sensing said object-to-be-scanned is a negative or a photograph by at least an image sensor;
selecting to turn on one of two optical lenses through a switching circuit, and controlling said light source in irradiating said object-to-be-scanned; and
fetching an image of said object-to-be-scanned by said optical lens, and focusing it on said image sensor to form said image, and converting said image into digital data for output.

15. The double-lens optical scanning method as claimed in claim 14, wherein said object-to-be-scanned is placed on a scanning stand, said scanning stand comprises a negative scanning stand, a photograph scanning stand, and a slide scanning stand, and said negative scanning stand and said slide scanning stand are placed in a side-by-side juxtaposition arrangement.

16. The double-lens optical scanning method as claimed in claim 15, wherein said light source is located between said photograph scanning stand and said negative scanning stand, and sensing results of said image sensor is used to determine forward irradiation or backward irradiation of said light source.

17. The double-lens optical scanning method as claimed in claim 14, wherein light paths of a negative or a photograph of said object-to-be-scanned are different, and scanning of said object-to-be-scanned is realized through switching said optical lens of different light paths.
